(19) United States
(12) Patent Application Publication
(10) Pub. No.: US 2014/0052809 A1
(43) Pub. Date: Feb. 20, 2014

(54) Token Based Applications Platform Method, System and Apparatus

(71) Applicant: Mobile Technology Holdings Limited, Douglas (IM)

(72) Inventors: Seppo Reino Keronen, New South Wales (AU); Michael Man Ho Mak, New South Wales (AU); Martin Haubek, Sydney (AU)

(73) Assignee: Mobile Technology Holdings Limited, Douglas (IM)

(21) Appl. No.: 13/947,206

(22) Filed: Jul. 22, 2013

Related U.S. Application Data
(63) Continuation of application No. 12/071,109, filed on Feb. 15, 2008, now abandoned.
(60) Provisional application No. 60/901,347, filed on Feb. 15, 2007.

(51) Int. Cl. H04L 29/08

(52) U.S. Cl. CPC H04L 67/2842
USPC 709/213

(57) ABSTRACT

A method that enables the mapping of token identity and token presentation context to invoke one or more applications that are associated with the given token and context is disclosed. The method enables the construction of a flexible and efficient token-in-context services platform.

### CROSS-REFERENCE TO RELATED APPLICATIONS

The present application is related to International Application No. PCT/AU2005/001799 entitled ELECTRONIC COMMERCE SYSTEM, METHOD AND APPARATUS, filed on Nov. 29, 2005 and published on Jun. 15, 2006 as WO 2006/060849, which claimed priority to Australian Provisional Application No. AU2004906982, filed on Dec. 7, 2004; U.S. application Ser. No. 10/591,694 entitled MOBILE TICKETING, filed on Sep. 1, 2006, which was a National-Stage of International Application No. PCT/AU2005/000276, filed on Mar. 1, 2005 and published on Sep. 21, 2005 as WO 2005/083640, which claimed priority to Australian Provisional Application No. AU 2004901046, filed on Mar. 1, 2004; and U.S. Provisional Application No. 60/842,356 entitled DISTRIBUTED ELECTRONIC COMMERCE SYSTEM, METHOD, AND APPARATUS, filed on Sep. 6, 2006. Each of these applications is incorporated herein by reference in its entirety.

### BACKGROUND OF THE INVENTION

1. Field of the Invention

The present invention relates generally to an electronic commerce system, method, and apparatus. The disclosed method, system, and apparatus may be utilized to construct a system and apparatus for providing services based on electronic and physical tokens.

2. Description of Related Art

Electronic commerce transactions that employ a mobile wireless communications device, for example a cellular telephone handset, are recognized as a commercially valuable opportunity for new electronic-token based services.

Text strings, such as those disclosed in PCT/AU2005/001799, and barcodes of various symbologies, encoded and transmitted as messages and displayed on the device screen, have been employed to represent electronic tokens. Barcodes rendered on mobile phone screens and RFID (Radio Frequency Identifier) tags, and extensions such as the NFC (Near Field Communications) technology, are used in field trials as electronic tokens. The trials have offered ticketing services to entertainment events and public transport services. Electronic tokens may also be employed in a wider variety of services in which the electronic-token replaces a key, voucher, ticket, loyalty card and other such physical token.

Recently consumer services have been implemented as web applications. Examples of such services include payments acceptance and processing, online access to digital media content, product promotions, auctions, dating services and many others. Such web applications typically employ an Internet browser and one or more web application servers. The web application server supplies a client application in response to a “GET <URI>” request from a client browser. The client application may be a simple static HTML markup page or digital media file to be presented to the consumer, or it may be a complex executable application that employs EcmaScript, Python or another programming language to implement business logic and asynchronous application server requests, for example AJAX, to communicate with databases and other application services.

Throughout this disclosure the term “client” is used to denote a web browser or other resource interpreter and the device hosting the browser or interpreter. The term “web application server” or “application server” is used to denote a web server that responds to HTTP or other protocol requests for resources or SOAP, XML RPC or other protocol web service or similar requests.

Web applications often employ customer identifiers, browser cookies, session identifiers, barcode product identifiers and so on to request one or more URIs associated with the given identifier from an application server. The term “URI”, for Uniform Resource Identifier, is used throughout this disclosure to denote the resource locator, resource identifier, resource name and similar schemas used to individuate resources on private networks and the Internet.

U.S. Pat. No. 6,542,933, entitled “System and Method of Using Machine-Readable or Human-Readable Linkage Codes for Accessing Networked Data Resources” and incorporated herein by reference in its entirety, describes a method for associating a proprietary URI template with a barcode token to instantiate the URI template as a complete URI with parameters to be submitted as a request to an application server to construct a customized HTML page or other web content resource to be returned to the client. The method disclosed in U.S. Pat. No. 6,542,933 does not employ client content caching efficiently. Specifically, the client cannot cache the resource, since the resource is dynamically constructed by a web server. Any subsequent request with different parameters needs to be answered by a fresh construction of the resource by a server and subsequent transmission of the resource from the server to the client. Consequently the method results in unnecessary delays, expensive network traffic and poor scalability of the system. The method does not address the association of multiple URIs with a token scan. The method also does not employ client context to customize the service. Client context includes, for example, geographic location, physical service context such as a request for payment, ticket, proof of membership, restrictions on available services placed by the client owner/operator and so on. U.S. Pat. No. 6,542,933 also fails to provide a secure client platform for the execution of services.

Therefore, the need exists for an alternative method to associate web content and more generally any number of web applications with a barcode, RFID, bCODE or other physical or electronic token (linkage code). The method, system, and apparatus disclosed here overcomes the shortcomings of the methods discuss above.

### SUMMARY OF THE INVENTION

Economic progress in the last several decades has largely been achieved by the introduction of electronic means to accomplish tasks that have previously been accomplished by purely physical means. In certain embodiments of the present invention relates to replacing physical tokens and procedures associated with their use with electronic tokens and the new procedures required to accomplish the same tasks, as well as new ones, by means of electronic-tokens.

Specifically, the transition from a physical means to an electronic means to accomplish a task is often initially unsuccessful, as the persons performing the task do not understand the new tools and the new procedures required to accomplish the task. Sometimes even after decades of development, the electronic means remain underutilized or even unused due to this problem. Even popular consumer electronics items, such as microwave ovens, video recorders and media entertainment systems are often underutilized and a source of frustration to consumers due to the lack of natural, readily understood interaction metaphors and interaction means.

Current methods to associate, execute and present services that employ electronic tokens require much work to design and install infrastructure, custom hardware devices and software to deliver the services. For example, as discussed above, U.S. Pat. No. 6,542,933, describes a method for associating a proprietary URI template with a barcode token to instantiate the URI template as a complete URI with parameters to be submitted as a request to an application server to construct a customized HTML page or other web content resource to be returned to the client. However, like other conventional methods, the method disclosed in U.S. Pat. No. 6,542,933 does not employ client content caching efficiently. Specifically, the client cannot cache the resource, since the resource is dynamically constructed by a web server. Any subsequent request with different parameters needs to be answered by a fresh construction of the resource by a server and subsequent transmission of the resource from the server to the client. Consequently, conventional methods result in unnecessary delays, expensive network traffic and poor scalability of the system. Conventional methods also fail to address the association of multiple URIs with a token scan and do not employ client context to customize the service. In certain embodiments, client context may include, for example, geographic location, physical service context such as a request for payment, ticket, proof of membership, restrictions on available services placed by the client owner/operator and so on. U.S. Pat. No. 6,542,933 also fails to provide a secure client platform for the execution of services.

Certain embodiments of the present invention overcome these shortcomings by employing existing Internet communications and applications infrastructure, client and server apparatus, content and application development tools. Specifically, the present application discloses a novel mechanism to associate tokens with service applications that are relevant in a specific service context, and to customize the applications for the service context. The service applications may be developed using existing web application development methods and tools.

Existing apparatus for accepting electronic tokens to access the associated services rely on existing desktop computer user interaction models to present the collection of stored electronic tokens. A short line of text with an optional 2-dimensional graphical icon is typically used to represent a stored electronic token. These items are typically presented as a vertically stacked selection list or menu. Alternatively, a two dimensional selection matrix of icons is occasionally used. In certain arrangements, consumers may find it difficult to find the token of interest on the small screen of a mobile device using such existing user interaction widgets.

The representation of physically based user interaction metaphors can provide for comfortable, readily understood, accepted and effective use of an apparatus without the need for extensive training. As an example a trash-can graphical symbol is often employed on computer desktops to denote the deleting of computer files and folders. In this example, the trash-can, desktop, files and folders are all physically based metaphors for digital data and associated computer operations.

In certain embodiments, the present invention presents a user interaction metaphor and user interaction means readily understood by consumers to accomplish the consumption of services based on tokens.

### BRIEF DESCRIPTION OF THE DRAWINGS

Additional objects, features, and advantages of the present invention will become apparent from the following detailed description of embodiments of the invention in conjunction with the accompanying drawings where like reference numerals indicate like features, in which:

FIG. 1 is an embodiment of a client apparatus touch-screen user interface, displaying multiple available payment services in response to a token scan;

FIG. 2 is an embodiment of a client apparatus touch-screen user interface, displaying multiple available heterogeneous services in response to a token scan;

FIG. 3 is an embodiment of a client apparatus touch-screen user interface, displaying an available payment service;

FIG. 4 is an embodiment of a client apparatus touch-screen user interface, displaying the operation of a payment service;

FIG. 5 illustrates an embodiment of a client apparatus touch-screen user interface schema;

FIG. 6 is an embodiment of a client apparatus touch-screen user interface, illustrating the operation of an alternative manual token entry interface;

FIG. 7 illustrates an embodiment of the invention as client token scanner apparatus for token based services;

FIG. 8 displays the structure and communication flow for an embodiment of the invention as a system providing electronic token based services;

FIG. 9 displays the structure and operation of a client apparatus according to an embodiment of the invention;

FIG. 10 displays an alternative construction of a client apparatus that as two separate connected devices in accordance with an embodiment of the invention;

FIG. 11 illustrates the Client Context, Context Sharing and Token Resolution process of an embodiment of the invention;

FIG. 12 illustrates the token resolution result and application launch in context for an embodiment of the invention;

FIG. 13 displays a simple embodiment of a Map of Tokens to URIs for the Token Resolution element of the invention;

FIG. 14 displays an embodiment of a Map of Tokens to URIs for the Token Resolution element in accordance with an embodiment of the invention;

FIG. 15 illustrates the Server Context, Context Sharing and Token Associations of an embodiment of the invention;

FIG. 16 displays the Token Resolution process of an embodiment of the invention;

### DETAILED DESCRIPTION OF EMBODIMENTS

There are many types of physical and electronic tokens. For example, passive and active RFID (Radio Frequency Identification) tags, including NFC (Near Field Communications) technology are employed as unique identifiers attached to physical objects and as tokens to identify a consumer's entitlement to receive goods and services. Barcodes of various symbologies, including 1-dimensional and 2-dimensional codes, such as CodeMatrix and QR-codes for example, can be stored in electronic form, printed on paper as a physical token or rendered on a mobile device screen to provide a purely electronic form of a token. As a further example, text strings may be rendered on a mobile device screen and scanned such as the technology disclosed in PCT/AU2005/001799 for providing an electronic token. Many other technologies, such as NFC, Bluetooth or WiFi radio, IrDA and other infra-red and visible light, DTMF and other audio patterns may also be used to represent tokens. Throughout this disclosure, the term “electronic token” or “token” is used to denote any of the above and similar types of tokens.

There are also many token based services including the for example, tokens that may be employed as tickets to sporting events, film screenings and other ticketed events and premises. Tokens may also be employed as vouchers providing proof of entitlement to forms of value, such as physical and digital goods, services and discounts. Tokens may also be employed as customer loyalty identifiers for frequent flier programs, coffee-shops and so on. Tokens may be employed as proof-of-membership for clubs, societies and other organizations. Tokens may be employed as keys providing access to buildings, hotel rooms, motor vehicles and other venues and equipment. Tokens may be used as payment credentials with cash, debit accounts or credit accounts. Throughout this disclosure the words “token based service” or “service” are used to denote any service employing any form of a token.

Many types of apparatus may be employed to provide access to an electronic token and the service or services associated with physical and electronic tokens. Examples of such apparatus include: Devices used by consumers to gain access to, store, select and present electronic tokens, including cellular telephone handsets, digital music players, game devices, digital cameras and other portable electronic devices. Devices used to dispense goods and services, such as vending machines, on presentation of an electronic token. Devices used to provide access to ticketed premises, such as turn-styles and gates. Point-of-sale equipment used to present proof of entitlement to goods, services and discounts, accumulate loyalty value, accept payment tokens, present product promotions and so on. Electronic kiosks providing access to electronic tokens and services. The present invention may be employed to construct the linkage from a physical or electronic token to one or more associated services and user interaction means for any of the above types of apparatus.

The present disclosure details the construction of an applications platform.

The applications platform provides a method to associate a token with one or more services, and subsequently discover, configure, present and efficiently execute the services associated with the particular token to the consumer presenting the token to gain access to the services. The services enabled by the platform can take the form of a software application designed to execute on a specific hardware platform or preferably the form of a web application designed to run on any common Internet connected client device.

In embodiments, the applications platform provides services such as cinema and event ticketing, electronic payments, retail vouchers, advertising promotions and loyalty schemes, digital content distribution and other services that are based on physical and electronic tokens and needing to provide a convenient rich user experience for the consumers of the service.

The applications platform provides the mechanism to associate a service implemented as a web application with one or more digital tokens, invoke the service in the appropriate context on presentation of a token and execute and present the service to the consumer.

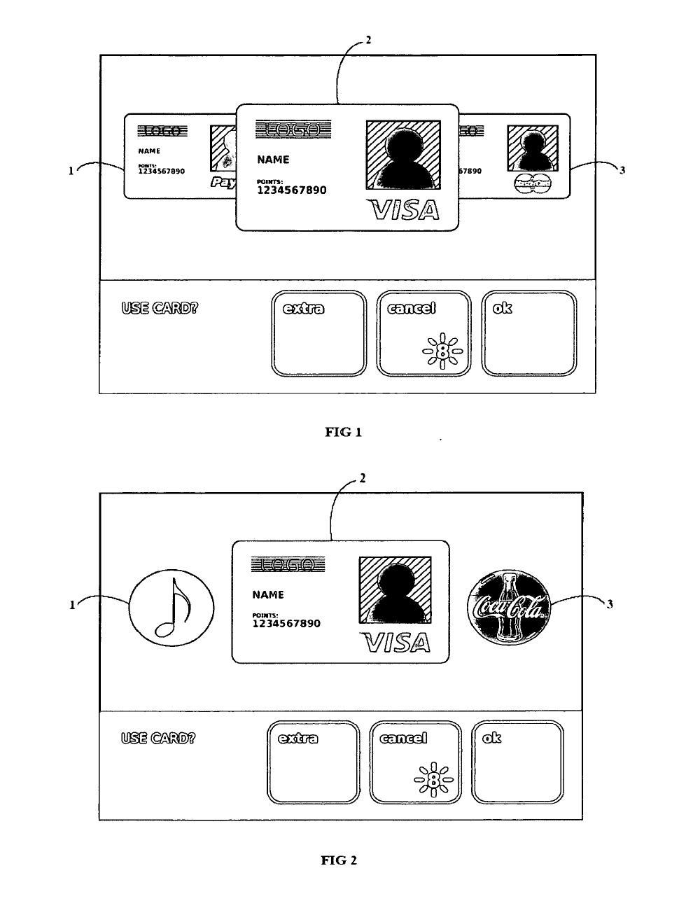

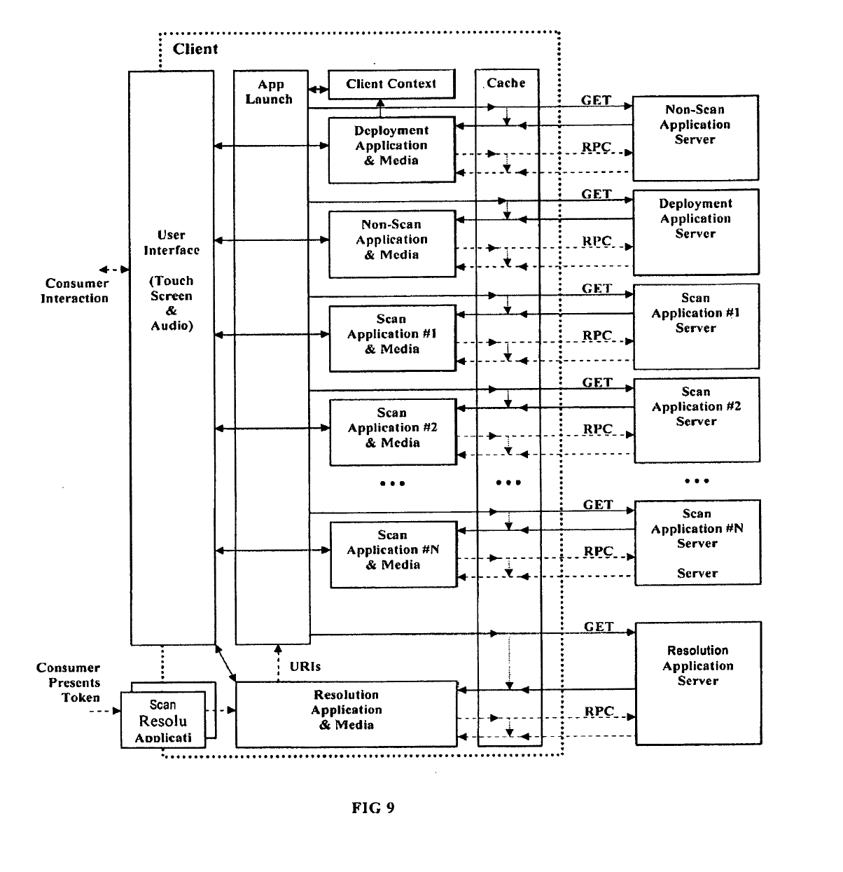

A convenient consumer experience is an important aspect of the present invention. FIGS. 1-6 illustrate the experience that a consumer encounters upon presentation of a token at the scanner apparatus such as the one illustrated in FIG. 7.

For the purpose of this description it is assumed that the consumer is in possession of a token, such as a short message, barcode, RFID token or NFC cellular telephone handset, for example.

FIG. 1 illustrates what the consumer experiences in response to presenting a token at a scanner apparatus located at a point-of-sale, where a payment is expected. The figure presents a graphical rendering of three payment services on a touch screen of the said scanner apparatus.

The applications platform has mapped the consumer's token to three relevant payment services available from payment providers and accepted by the merchant where the scanner apparatus is located. In this case the services are represented by graphical renderings of payment cards familiar to consumers. A preferred payment service (e.g., VISA) is presented more prominently, larger, and centered, than the other two payment services.

The consumer may select the preferred (in this case VISA) service by either touching the rendered payment card or the rendered “ok” button at the bottom right of the touch screen. The consumer may select one of the alternate two payment services by touching one of the other rendered cards. The consumer may bring one of the non-preferred cards to the center position by “dragging” the desired card to the center. The consumer may exit the service by touching the “cancel” button. The consumer may request to view any other services available to him by touching the “extra” button.

More generally, relevant services may be represented as 3 dimensional or 2-dimensional graphical rendering of an object that is associated in the consumer's mind with the service being offered. In embodiments, these graphical items are rendered in a photo-realistic form with motion of the item resulting in appropriate lighting, shadow and audio effects.

FIG. 2 presents another example of a consumer experience in response to a token scan. The application platform has mapped the token to three relevant services including: a payment service (e.g., VISA), a voucher for a free beverage (e.g., CocaCola) and a service that will download a digital music item to the consumer's mobile music device. The consumer may select, cancel or expand as described above.

FIG. 3 illustrates the user experience in the case that the user has selected the preferred payment service, or the case that a single payment service is determined relevant by the applications platform. A menu bar component (1) is rendered by an Application Manager component, described below. The menu component consists of a set of buttons (2), (3) and (5) and a prompt or information element (6). Buttons may contain added elements, such as the illustrated count down element (4), providing the user a limited time to respond, and in this case a timeout that prevents the subsequent misuse of the valuable application by another consumer.

Note that an application rendering user interface elements has access to information about the consumer (customer) as part of the Client Context component of the platform, described below. As an example, the context preferably includes an information element that specifies the natural language, in this case English, understood and preferred by the consumer. An application is hence enabled to discover what natural language strings to render as part of the interface. More generally, the context may include other information, such as disabilities or cultural preferences and restrictions for example, enabling applications to tailor the interface such that it is appropriate for the individual customer.

Further, FIG. 3 illustrates that the card representing the service “flies” in from the direction of the location where the token scan took place. In this case the scan area is located to the right of the touch screen, referring to the scan apparatus of FIG. 7, where the scan area is marked as (3).

In FIG. 3 the card (8) representing the service is rendered in a realistic fashion, with shadows, highlights and other 3D rendering effects. Additional rendering may also be included to enhance the user's experience. In this case, an image from the bCODE scan camera may be mapped onto the card as if reflected from the cards glossy surface. These rendering effects cannot be displayed in the line drawing style of FIG. 3, but are an important aspect of the consumer experience. Similarly the movements of the card and consumer interactions may be accompanied by audio ques rendered using a speaker of the scan apparatus.

FIG. 3 also illustrates the personalization elements of the service, displaying a custom “logo” (9), consumer's name (10), accumulated loyalty points (11) and an image (12) of the consumer. These details may be employed for verification of consumer's identity. These consumer data may be made available in this case by the Token Resolution server component of the platform, as described below.

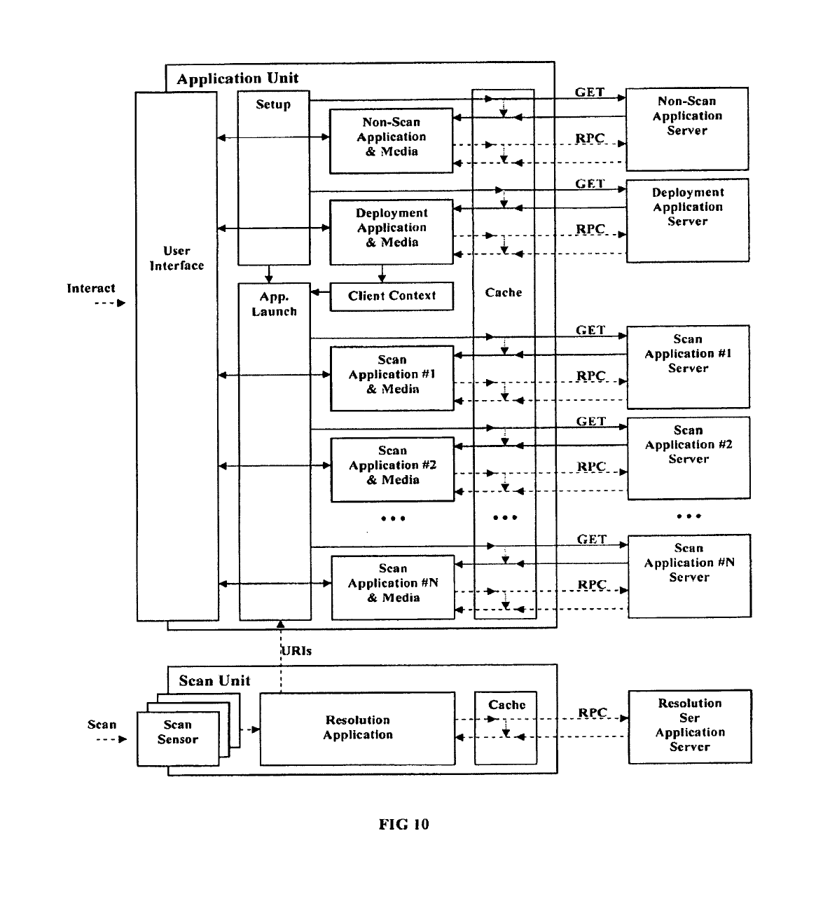

Once the consumer has selected a service, the service is executed by an Application Manager component of the platform, see, for example, FIGS. 9 and 10. Alternatively, in certain embodiments, another application that is a container for the selected application may perform the duties of an Application Manager.

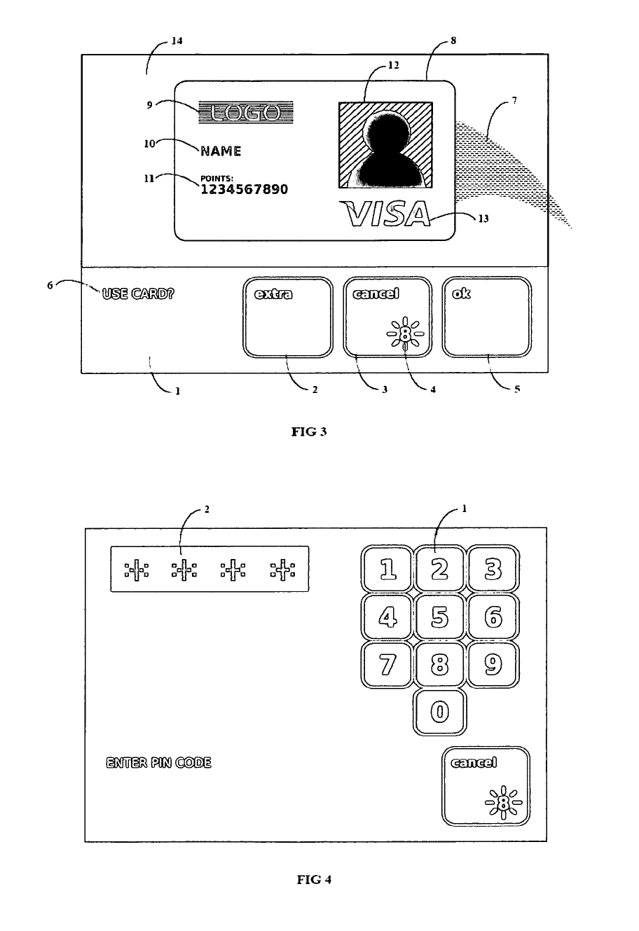

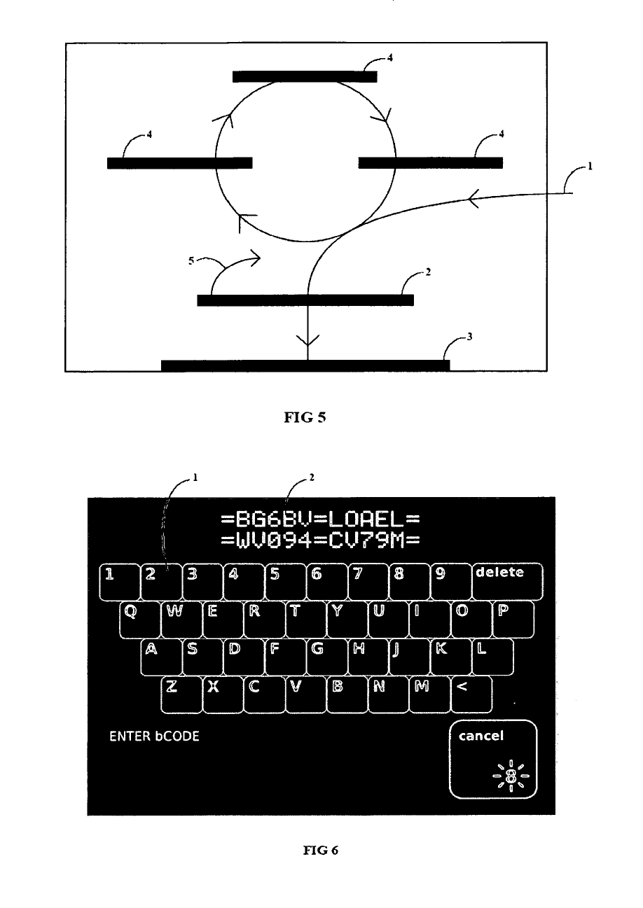

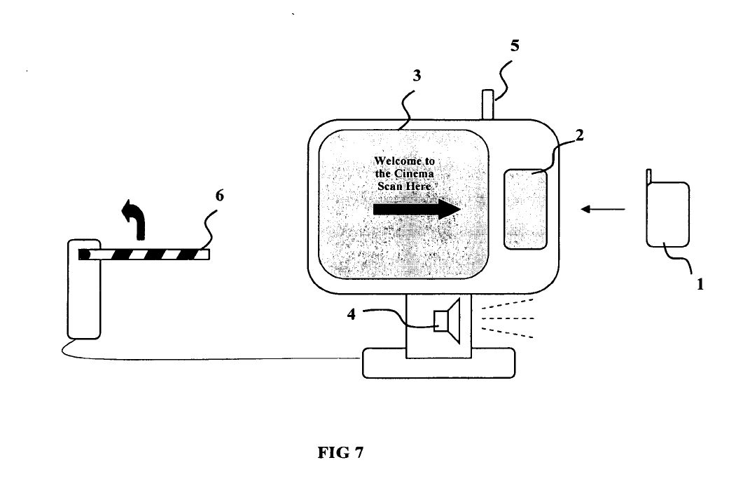

FIG. 4 illustrates the execution of an exemplary payment service. In this illustration the payment service requests the consumer to enter a secret personal identification number (PIN) for security. Alternatively the payment application may request the consumer for a sign-on-glass on the touch screen, fingerprint scan or other identification procedure.

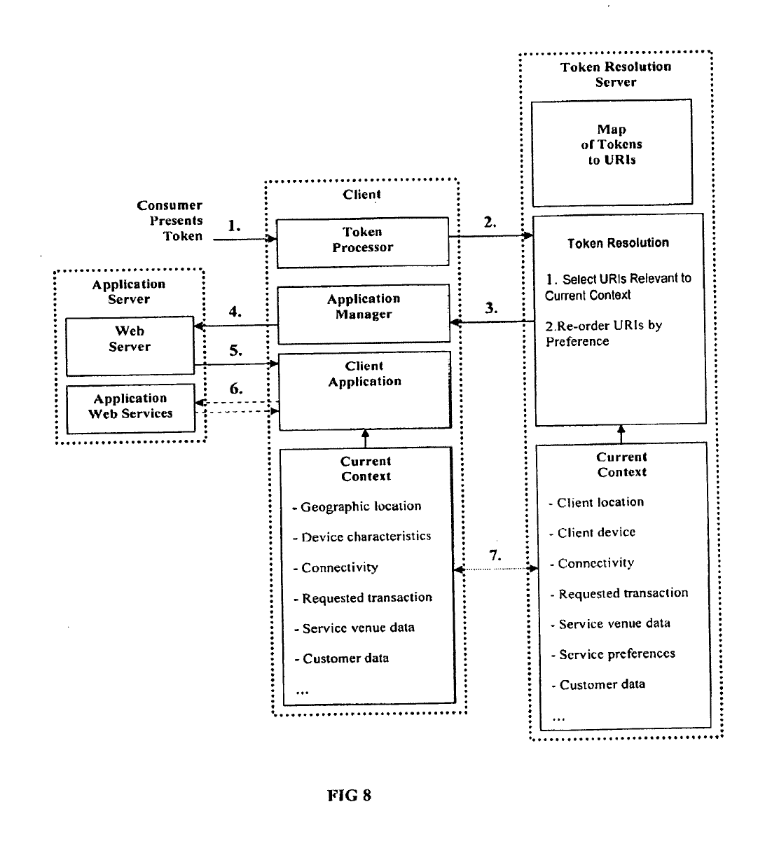

FIG. 5 illustrates the schema of an embodiment of the touch screen user interface. A rendered representation of a service enters the scene (1) from the direction where the token scan was performed. In this case the direction is from the right, where the token scan means of the apparatus illustrated in FIG. 7 is located.

One of the services is presented in a front-center prominent position (2). On selection the front-center item gains focus (3) and the application manager requests it to execute with focus. In certain embodiments, the initially prominent service positioning may be provided to the service provider in return for a fee. Other preferred service positioning arrangements can be implemented by persons skilled in user interface design.

Any remaining services (4) are arranged on a “carousel” behind the front-center item. The carousel may turn autonomously or as directed by touch screen “drags” by the consumer. In addition the individual service items may spin (5) to reveal additional information and user interaction affordances. Although only a limited number of services are shown, it should be readily understood that any number of services can be utilized in various embodiments of the present invention.

FIG. 6 illustrates yet another aspect of the user interaction. The token scan operation may be replaced by manual input of a scan code or other identification information by the consumer. The identification entered in this example is a bCODE string. In alternative embodiments, the identifier may be an MSISDN number, keyword, search string or other such information that the platform will associate with relevant services. As an example, the consumer may enter the word “soft drink”. The platform may associate this string with services that introduce the various soft drinks available at the merchant location of the scanner. Such, in context, associations of tokens and other information items may be implemented as part of the Token Resolution service described below. Alternatively a separate search engine implementation may be employed to associate search terms, other than token identifiers, with relevant content or applications. Effective techniques for performing in-context search are known.

FIG. 7 displays an embodiment of a scanner apparatus that employs the above exemplary user interaction method. A cellular telephone handset (1) is brought to just touch the scan area (2). Alternatively other forms of token, such as printed barcodes or plastic cards incorporating an RFID tags for example, may be scanned.

The token scanner apparatus illustrated in FIG. 7 incorporates a bCODE camera based scan component and a 13.56 MHz NFC RFID scan component, for example. The scan area incorporates a capacitive proximity sensor, which triggers both the visual scan and the NFC radio frequency scan of the consumer cellular phone. The visual scan may be extended to recognize printed barcodes and other visually recognized tokens. The RFID scan sensor is able to interrogate many forms of RFID tags. More generally many additional forms of token scan sensor may be incorporated as part of the apparatus. As a further example, a magnetic stripe reader for debit/credit card scans may be incorporated within the scan area or as a separate peripheral device.

In the case that a visual scan is displayed on the screen of the scanned cellular handset, the visual scan is processed by the platform. In the case that an NFC RFID is detected, the RFID identifier is processed by the platform. In the case that both tokens are detected, the association of the visual scan and RFID is recorded as part of the platform token resolution database. In each of these cases the Token Resolution step returns one or more relevant service URIs.

The relevant URIs returned by Token Resolution are used to retrieve services. The services are visually displayed on the touch screen (3) and aurally rendered on the speaker (4), as described above.

In certain embodiments, the scanner apparatus may incorporate a WiFi and/or Bluetooth radio (5), that services may employ to download content to the consumer's telephone handset and further interaction with the consumer by means of a mobile cellular telephone handset interface.

In this embodiment, the scanner apparatus is connected to a gate (turnstile) mechanism (6) that a selected, executing service may operate to allow the consumer to enter a ticketed venue. In embodiments the invention may incorporate other peripheral devices, such as a point-of-sale cash register for example. The scanner apparatus may also incorporate Internet connectivity and a signed security certificate to enable authenticated, private communications with remote services, including, for example, a Token Resolution service and Application Servers.

FIG. 8 illustrates the main system components and specifies the processing steps performed by the Applications Platform. The Client component in this and subsequent drawings corresponds to the scanner apparatus shown in FIG. 7. In alternative embodiments all or part of the Client functionality may be implemented on a mobile device or backend server. For example, a programmable cellular smart phone, incorporating a camera and RFID reader may be employed as the Client. Other re-factoring of functionality will be readily apparent to a person skilled in the art.

A Token Processor accepts (1) a token scan and requests (2) a resolution of the token to reveal the URIs relevant to the token in the current context. Token Resolution finds URIs associated with the token in the Current Context. The returned URIs (3) are used by an Application Manager to request (4) the Client Application code and content from an Application Servers for the said URIs. The result (5) Client Applications and content are cached by the Client. In the case that the Client Application consists of non-executable content, such as a static web page or video stream for example, the Application Manager displays an icon representing that service. In the case that the Client Application is executable, the Application Manager requests that the Client Application initialize and render an iconic representation of itself. Subsequently, in response to consumer selection, the Application Manager invokes the rendering of non-executable content or full execution of an executable Client Application. In certain embodiments, the rendering and execution are performed by an Internet browser plug-in module that understands the MIME type of the Client Application. During execution, an application will typically communicate (6) with an Application Server using SOAP, XML-RPC or other application protocol.

As illustrated in FIG. 8, both the Token Resolution process and the executing Client Application have access to a Current Context. The Current Context consists of data items that reveal the current geographic location of the Client apparatus and other device information, information about the consumer to whom the token was issued or to whom the token may have been forwarded, administrative policies of the venue where the client apparatus is located and so on. Certain elements of the Current Context are initially known at the Client and others at the Token Resolution server. A synchronization protocol (7) may be employed to produce a shared, consistent Current Context. In the present embodiment, context synchronization (sharing) is performed as part of the resolution request and response protocol. A person skilled in data communications may readily design alternative synchronization protocols.

FIG. 9 illustrates the construction and operation of a Client embodiment in detail. An Application Manager (App Launch) communicates with a number of Application Servers. The Application Manager employs HTTP protocol GET requests to fetch Client Application code and media from the Application Servers. The application code and media are cached by the client with a typical time-to-live interval of several hours. As an enhancement, the cache component may pro-actively refresh Client Application code and content that has been executed within the last 24 hours or other suitable interval.

FIG. 9 illustrates a typical flow of Client Application invocations, starting with a Deployment Application, which is used by venue staff to configure the Client Scanner apparatus. The Deployment Application initializes much of the Client Context part of the Current Context available to the remaining Client Applications during their execution. Subsequently a Non-Scan Application is launched, which displays advertising content on the Client screen during the time that the client device is otherwise idle. Subsequently, the Application Manager launches Scan Applications as tokens are scanned. Token scan processing on the client side is performed by a Resolution Application. The Resolution Application also has access to the user interface to inform the consumer of any problems encountered in resolving the token. As an example, the connection to a resolution server may be unavailable, the token may have expired and so on.

An aspect of the invention is the ability to cache Client Applications and Token Resolution results by the client. Application caching is effective because the Current Context is available during Client Application execution. The alternative strategy, where a server executes instructions that customize the content may not be effective for caching, as any change in context requires that the content be downloaded to the client again. Caching of token resolution results may be effective because tokens map to static URIs, which are not customized by the server depending on the current context. Further token code space may be allocated in blocks that map to the same URI or URI set.

FIG. 10 illustrates a re-factoring of the client as two separate physical devices connected by a Universal Serial Bus (USB) connection cable. In this case the separate Application Unit may be a generic personal computer (PC) device that employs a web browser with plug-ins to execute applications. The Application Manager is implemented as a Javascript browser application. This embodiment may be unreliable due to the poor quality of existing Javascript implementations. As the quality of implementations improves, such an embodiment is expected to become reliable enough for deployment.

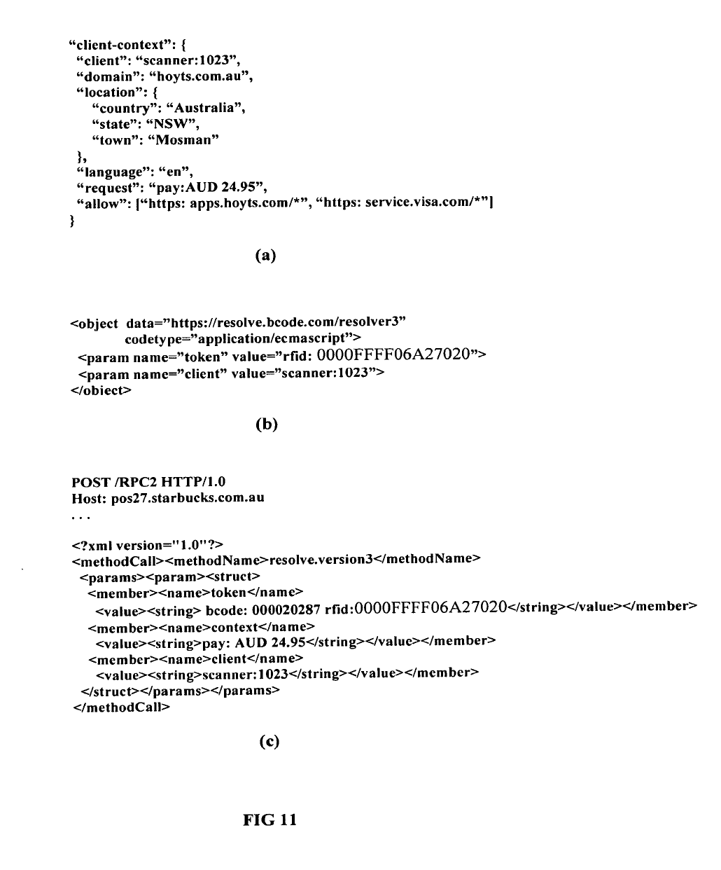

FIG. 11(a) is an instance of a Client Context displayed as a JavaScript Object Notation JSON structure. The structure contains a unique Client identifier to enable a Token Resolution server to readily identify information associated with a specific client. Note also that the structure includes a “request” parameter obtained from a point-of-sale device. The presence of the “pay” parameter enables the Token Resolution service to determine that a payment application able to service the given amount is relevant. The “allow” parameter specifies service URIs, as regular expressions, administratively acceptable for processing by the Client. The ordering of URIs in this “allow” list is used to determine an order of prominence for service presentation as described above. In general any contextual information that may be useful in mapping tokens to services or for use by executing services to provide better service may be included as part of the Client Context.

FIGS. 11(b) and (c) illustrate the form and content of Token Resolution requests. The example in (b) is a fragment of markup language that may be employed to invoke a client side Javascript Resolution Application of an RFID token detected by a scan sensor. Example (c) illustrates an XML-RPC request that is used by the client side Resolution Application to request mapping of an RFID token and a bCODE token that have been detected together. Note that the examples incorporate a unique Client identifier, enabling the Token Resolution servicer to take Client Context into consideration during the Token Resolution process. Elements of the Client Context that are not known by the Token Resolution server are incorporated as part of the Resolution Request. The “pay” parameter in (c) is an example of such an element. The Deployment Application, illustrated in FIGS. 9 and 10, communicates the more static elements of Client Context to the Token Resolution Server.

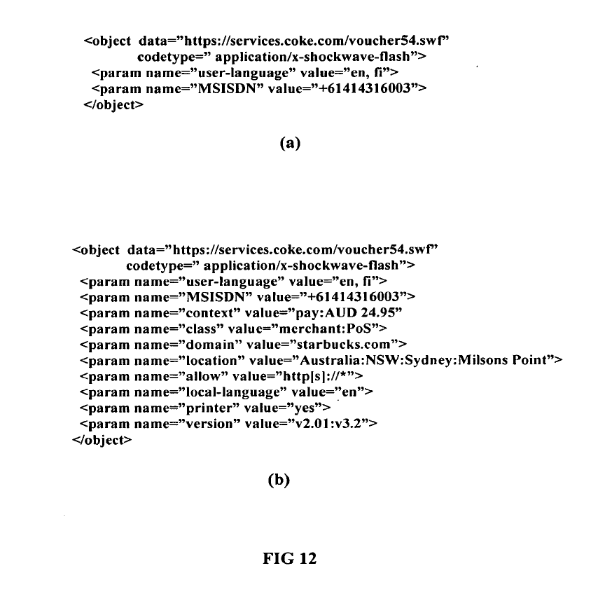

The Resolution Server returns a list of one or more service URIs in response to a Token Resolution Request. In the embodiment detailed here, the URIs are incorporated as part of markup language. The Token Resolution Server returns a sequence of markup <object> entities, such as the one illustrated in FIG. 12(a). Note that the reply markup also incorporates those elements of the Current Context known to the Token Resolution Server, but not the Client. The Client Application Manager adds these elements to the Current Context for the application being launched, as illustrated in FIG. 12(b). As an example, the cellular mobile telephone number (MSISDN) of the individual consumer is known by the Resolution Server, but typically not by the Client. The MSISDN is returned to the Client, which includes the MSISDN as a parameter for the Client Application. The Client Application in turn may employ the MSISDN as an index parameter to retrieve and store information about the individual consumer. In alternative embodiments a service provider customer-id may be used instead of the MSISDN for this purpose.

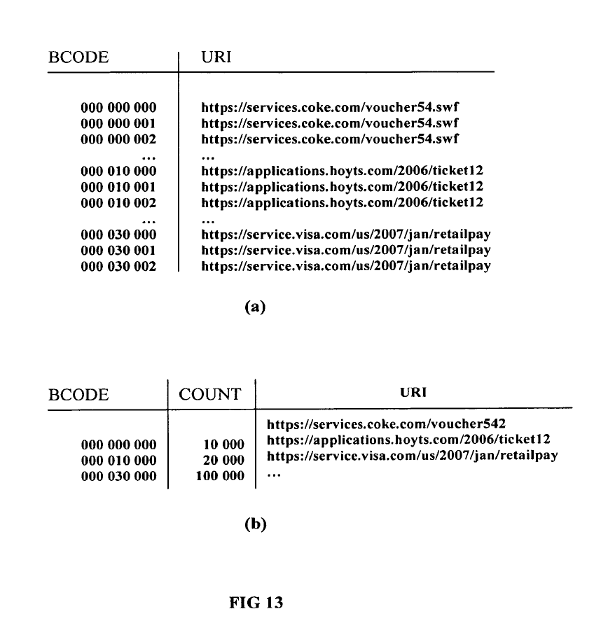

The Resolution Server employs a database Map of Tokens to URIs as part of the process of mapping tokens to URIs. FIG. 13 illustrates such a Map. In the case of token identifiers that are issued by the platform, blocks of sequential identifiers are preferably mapped to the same URI or URIs. Such a Map has a more compact representation, as illustrated by the equivalence of FIGS. 13(a) and (b). In simple cases, Clients may perform the mapping of tokens to URIs using cached entries of such block allocations.

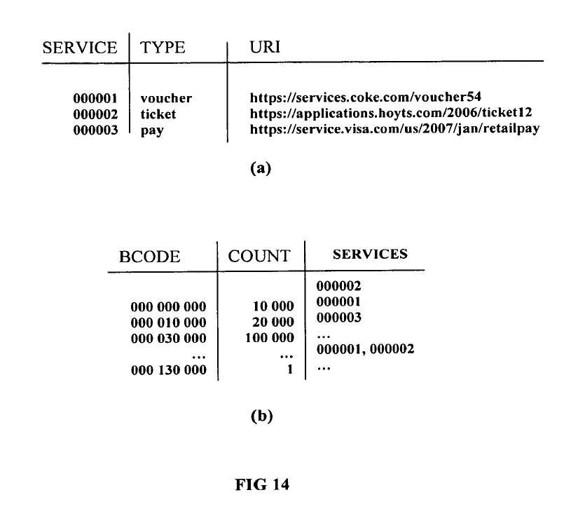

FIG. 14 displays a more expressive representation of the Map of Tokens to URIs, employing unique service identifiers. This representation does not assume any preferred underlying token type, such as bCODE, enabling a more natural mapping of multiple token types to URIs. FIG. 14(a) also illustrates a “type” parameter that is employed to determine the relevance of a service to a “request” element of Client Context. FIG. 14(b) also illustrates the mapping of a bCODE to more than one service. A person skilled in information technology can readily construct alternative representations of the Token to URIs Map.

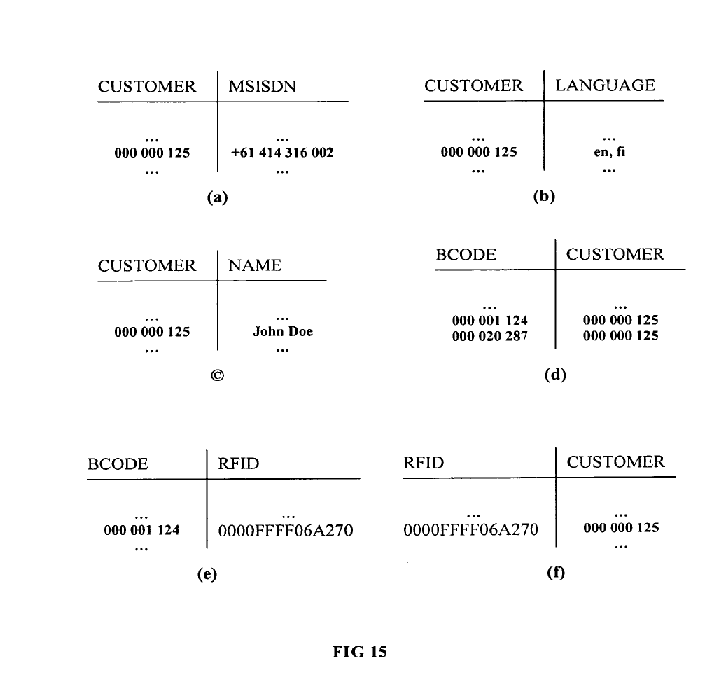

As well as performing a mapping function from tokens to URIs, the Token Resolution Server maps the token to the consumer to whom the token was issued. The Token Resolution Server incorporates a database of individuating information about the consumer (customer), as illustrated in FIG. 15. The information may include the consumer's cellular telephone number (MSISDN), name, address and so on. In the case of services, such as payments, that may require strong authentication of the customer, this mapping is an important element of the service. In other cases the mapping may be informative only or ignored by the service in question. In the case of that strong additional authentication of the consumer is required, the database may include personal identification numbers, signature samples, identifying images, digital fingerprints and so on. Alternatively an Client Application may employ an external service to supply the necessary identification elements and functions.

FIGS. 15(e) and (f) also illustrate that the Token Resolution service may establish a mapping across separate token identifier domains. In this case a token and an RFID token have been observed simultaneously during a token scan. The result is the discovery of the RFID of a cellular telephone employed by the consumer. The strength of the association depends on the degree of authentication of the consumer performed following the scan in question. A Client Application may be constructed to establish consumer identity to establish a strong association. Subsequently the discovered RFID may be resolved to relevant service URIs by the Token Resolution Server.

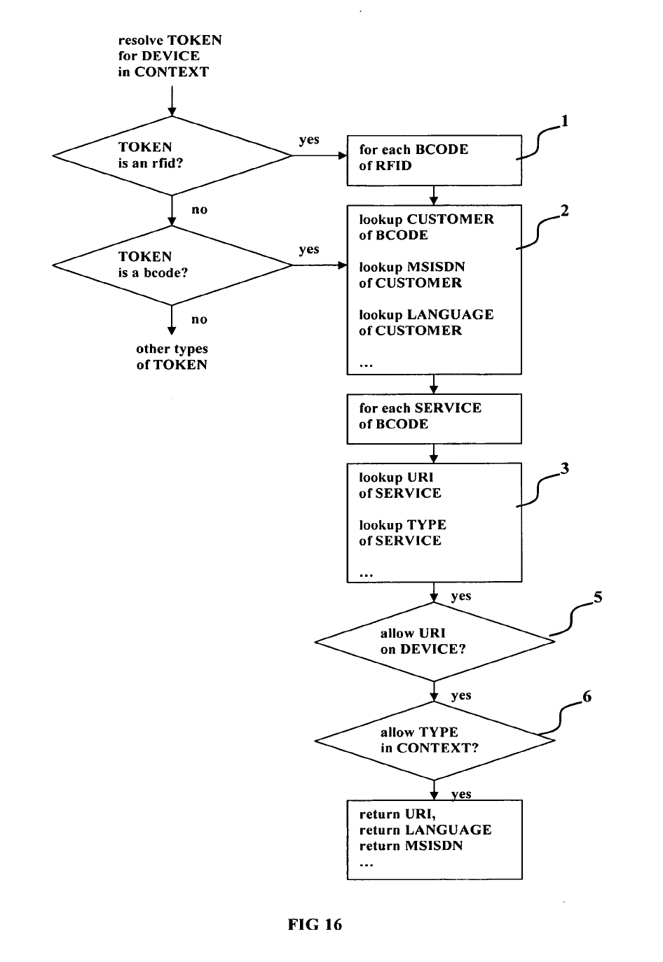

FIG. 16 illustrates an embodiment of the token to URI mapping and relevant URI selection process performed by a Token Resolution Server. The capitalized terms in this flow diagram refer to the attribute names in the database schema illustrated in the preceding two figures. In the case of an RFID token, the mapping from RFID to zero or more bCODEs is determined in (1). Consumer (customer) information is determined in (2). The specific service URI and service type is looked up in (3). Steps (4) and (5) use the known Current Context to filter out URIs that are not accepted by the scanner in question or which are not otherwise relevant in the Current Context. Finally the results are collected in the form described above for return to the requesting Client. A person skilled in information technology may employ alternative and more elaborate methods, such as forward or backward chaining rules for example, to implement token to URIs mapping and selection. A separate customer relationship Management (CRM) server may be employed to manage customer data.

Many alterations and modifications of the present invention will be comprehended by a person skilled in the art after having read the foregoing description. It is to be understood that the particular embodiments shown and described by way of illustration are in no way intended to be considered limiting. Therefore, references to details of particular embodiments are not intended to limit the scope of the claims, which in themselves recite only those features regarded as essential to the invention.

The embodiments described herein are intended to be illustrative of this invention. As will be recognized by those of ordinary skill in the art, various modifications and changes can be made to these embodiments and such variations and modifications would remain within the spirit and scope of the invention defined in the appended claims and their equivalents. Additional advantages and modifications will readily occur to those of ordinary skill in the art. Therefore, the invention in its broader aspects is not limited to the specific details and representative embodiments shown and described herein.

1. A method for providing a service based on a token, the method comprising:
accepting a token scan by a client device;
requesting, by the client device, of a resolution of the token to reveal at least one Uniform Resource Identifier (URI) relevant to the token in a current context;
requesting, by the client device, of a client application code and content from a server for the URIs; and
caching, by the client device, of applications and content such that a change in the current context does not require the content to be downloaded to the client device again.

2. The method according to claim 1, wherein the application consists of non-executable content.

3. The method according to claim 1, wherein the application is executable.

4. The method according to claim 1, wherein the application is rendered and/or executed by an internet browser plug-in module.

5. The method according to claim 4, wherein the token resolution process and the executing process have access to the current context.

6. The method according to claim 1, wherein the current context consists of data items that reveal at least one of a current geographic location of the client device or other device information, information about the consumer to whom the token was issued, administrative policies of the venue where the client apparatus is located.

7. The method according to claim 1, wherein a synchronization protocol is employed to produce a shared, consistent current context.

8. The method according to claim 7, wherein the synchronization is performed as part of the resolution request and response protocol.
